(19) United States
(12) Patent Application Publication
(10) Pub. No.: US 2014/0311347 A1
(43) Pub. Date: Oct. 23, 2014

(54) POLANILINE BASED MEMBRANES FOR SEPARATION OF CARBON DIOXIDE AND METHANE

(71) Applicants: Frantisek Svec, Alameda, CA (US); Natalia Blinova, Berkeley, CA (US)

(72) Inventors: Frantisek Svec, Alameda, CA (US); Natalia Blinova, Berkeley, CA (US)

(73) Assignee: The Regents of the University of California, Oakland, CA (US)

(21) Appl. No.: 14/362,032

(22) PCT Filed: Nov. 30, 2012
(86) PCT No.: PCT/US12/67416

§ 371 Date: May 30, 2014

Related U.S. Application Data
(60) Provisional application No. 61/565,914, filed on Dec. 1, 2011.

(51) Int. Cl. B01D 71/60; C08J 7/04; C08J 7/02; B01D 53/22; C08J 7/12

(52) U.S. Cl. CPC B01D 71/60; B01D 53/228; C08J 7/12; C08J 7/02; C08J 7/047; C08J 2379/02; C08J 2471/02
USPC 96/13; 525/540; 524/612; 524/377; 428/523; 428/220

(57) ABSTRACT

Various embodiments demonstrate that an in-situ polymerization enables deposition of a homogeneous polyaniline layer with a controlled thickness on top of a porous polypropylene support. Photografting and subsequent modification with diamines affords composite membranes featuring both high permeability and selectivity that are well suited for applications such as separation of carbon dioxide from a natural gas.

### CROSS REFERENCE TO RELATED APPLICATIONS

This application claims priority to PCT Application PCT/US2012/067416, filed Nov. 30, 2012, which in turn claims priority to U.S. Provisional Application Ser. No. 61/565,914 filed Dec. 1, 2011, which application is incorporated herein by reference as if fully set forth in their entirety.

### STATEMENT OF GOVERNMENTAL SUPPORT

The invention described and claimed herein was made in part utilizing funds supplied by the U.S. Department of Energy under Contract No. DE-AC02-05CH11231 between the U.S. Department of Energy and the Regents of the University of California for the management and operation of the Lawrence Berkeley National Laboratory. The government has certain rights in this invention.

### BACKGROUND OF THE INVENTION

1. Field of the Invention

The present invention relates to the field of membranes utilized for gas separation.

2. Related Art

The problem of thermodynamically efficient and scalable carbon dioxide (CO₂) capture stands as one of the greatest challenges for modern energy researchers. Pipeline specifications for natural gas require removal of the CO₂ to a level below 2% to avoid problems such as pipeline corrosion, additional compression cost and reduction of gas heating value. Membrane-based technologies enabling removal of CO₂ from natural gas promise high separation efficiency while being less capital and energy intensive compared to other common methods such as scrubbing, pressure swing adsorption, and cryogenic separation.

Polymer-based membranes for gas separation promise a great potential as an energy-efficient alternative to other methods including standard absorption, pressure-swing adsorption, and cryogenic separation. Fabrication of current membranes is a complex process which involves several steps such as material selection, drying, preparation of polymer solution, casting or hollow fiber spinning, phase inversion process, and post treatment. In order to make membranes a cost-effective alternative, their production must be simple, straightforward, and scalable.

However, the current commercial polymer membranes generally do not have selectivity high enough for a viable economic separation of CO₂ from natural and other gases. Such low selectivities for CO₂ are due to the solution-diffusion mechanism of transport for all gas species through these membranes.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 illustrates a SEM micrograph of a cross section of PANI-polypropylene composite membrane prepared by dispersion polymerization.

FIG. 2 illustrates a permeability/selectivity trade-off map for CO₂/CH₄ including the polyaniline membrane photografted with glycidyl methacrylate and 2-hydroxyethyl methacrylate and reacted with cystamine (open triangle) and hexamethylenediamine (open square).

FIG. 3 illustrates a scheme of functionalization of the polyaniline membrane first photografted with glycidyl methacrylate and 2-hydroxyethyl methacrylate and then reacted with 2-2′-(ethylenedioxy)bis(ethylamine).

FIG. 4 illustrates topographic AFM images of (a) original polyaniline layer, and (b) after photografting with glycidyl methacrylate and 2-hydroxyethyl methacrylate followed by modification with 2-2′-(ethylenedioxy)bis(ethylamine).

FIG. 5 illustrates a Robenson's plot of the empirical permeability/separation factor and upper bound relationship for separation of CO₂/CH₄ using membranes. Experimental points within the circle in the trade-off map represent permeability and separation factor α determined for a polyaniline membrane photografted with glycidyl methacrylate and 2-hydroxyethyl methacrylate reacted with 2-2′-(ethylenedioxy)bis(ethylamine) containing 80% poly(ethylene glycol) (PEG) 400 (square), 80% PEG 600 (triangle), and 80% PEG 1000 (circle).

FIG. 6 illustrates a device used for photografting.

### DETAILED DESCRIPTION

In the discussions that follow, various process steps may or may not be described using certain types of manufacturing equipment, along with certain process parameters. It is to be appreciated that other types of equipment can be used, with different process parameters employed, and that some of the steps may be performed in other manufacturing equipment without departing from the scope of this invention. Furthermore, different process parameters or manufacturing equipment could be substituted for those described herein without departing from the scope of the invention.

These and other details and advantages of the present invention will become more fully apparent from the following description taken in conjunction with the accompanying drawings.

An alternative to conventional polymeric membranes are membranes enabling facilitated transport (FTM) which have attracted attention because they can improve the selectivity at a larger flux, FTM may selectively permeate CO₂ by means of a reversible reaction of CO, with an incorporated functionality (carrier) in the membrane, whereas gases such as H₂, N₂, and methane (CH₄) will permeate exclusively by the solution—diffusion mechanism.

FTM can be prepared by swelling a polymer film with solvent, and subsequently introducing the carrier species by diffusion, or by ion exchange. FTM is usually tested and operated in a sweep gas permeation mode at low concentrations of reacting species where the partial pressure driving force is very low. This is particularly attractive for removal and sequestration of CO₂ when it is present in the feed at low concentrations. Great advances are being achieved by adding an amine as a carrier component in the membrane structure and by the choice of a suitable solvent having favorable differences in solubility and diffusivity between the two gases. The main selection criteria of the solvent are high solubility for CO₂ and low solubility for CH₄, low viscosity, low vapor pressure, low cost, and minimal environmental toxicity issues.

Various embodiments of the invention disclose the utilization of polyaniline (PANI) as a membrane material due to the readily available aniline monomer, stability, simple preparation, and ability to form thin homogeneous layers on the surfaces of other polymers. The in situ deposition of PANI layers on top of a porous support is a simple, continuous, and scalable method affording smooth submicrometer thin PANI films.

In various embodiments, the preparation of polyaniline is sensitive to variations in polymerization conditions that significantly affect morphology of the polyaniline layer. In one embodiment, the optimization of polymerization conditions enables the preparation of ultrathin, homogeneous, defect free PANI coatings with defined thickness attached to a hydrophobic porous polypropylene support thus forming a composite membrane. The protonated polyaniline layer is prepared in a single step using either of a precipitation, a dispersion, or an emulsion polymerization. The permselectivity of the composite membranes for carbon dioxide (CO₂) over methane has been tested in both dry and hydrated state. Subsequent chemical modification of the PANI layer led to significant enhancement of transport and separation properties.

An embodiment of the invention demonstrates that water (H₂O) utilized as a solvent plays an important role in the mass transport. Gas separation studies have shown that separation performance of supported polyaniline (PANI) membranes is significantly enhanced by the chemical modification in the presence of water. Results have shown a separation factor as high as 540 and permeability of 3460 Barrers (1 Barrer=3.348×10⁻¹⁹ kmol m/m² s Pa) for CO₂/CH₄ (10/90 by volume) gas mixture for PANI film containing guanidine functionalities. The disadvantage of using water as a solvent is the volatility of water that evaporates during the operation. Other limitations of using water include metal hardware corrosion and amine degradation. The effect of different amines attached to the surface of PANI composite film on gas transport rate and separation efficiency was also investigated.

### Experimental

### Preparation of Membranes.

A porous polypropylene film with a thickness of 25 μm and an average pore size of 0.043 tm (Celgard 2400, Charlotte, N.C.) was used as a support for the composite membranes. The polymerizations of aniline hydrochloride affording a polyaniline polymer film was carried out in a simple device. A circular piece of the polypropylene support with a diameter of 8.8 cm was placed on the top of a stainless steel base and sandwiched between the base and a top stainless steel ring fixed with screws to the base. A defined volume of a polymerization mixture solution was transferred in the cavity of the assembled device and polymerized for 2 hours. The polyaniline films were formed using a precipitation polymerization of 0.2 mol/L aniline hydrochloride initiated by 0.25 mol/L ammonium peroxydisulfate. Alternatively, the PANI films were also prepared via a dispersion and an emulsion polymerization using poly(N-vinylpyrrolidone) with a molecular mass of 55,000 as a steric stabilizer in the former and dodecylbenzenesulfonic acid as a surfactant in the latter polymerization process. Tungstosilicic acid (HWSi) was used to better control the thickness of PANI films.

After the deposition of the PANI film, the composite membranes were washed with 0.2 mol/L hydrochloric acid to remove the adhering polyaniline precipitate, then with methanol and dried in the air. The protonated polyaniline was converted to base with an excess of 0.1 mol/L ammonium hydroxide.

### Functionalization of Membranes

The composite membranes were modified using photografting. Photografting is a technique used in the study of polymers and more in specific polymeric biomaterials. Technically speaking it is the covalent incorporation of functional additives to a polymer matrix or polymer surface using a light-induced mechanism. It is an important technique for the modification of biomaterial surfaces. The PANI layer was wetted with a solution containing 25% glycidyl methacrylate, 25% 2-hydroxyethyl methacrylate, 50% t-butyl alcohol-water mixture (3:1) and 0.25% benzophenone (with respect to monomers) and then covered with a quartz plate previously treated with fluoroalkylsilane, and exposed to 360 nm UV light for 15 minutes. The photografted membrane was immediately immersed in 1,4-dioxane in order to remove all soluble polymers and kept there for about 1 hour. The membrane was then washed with methanol and dried. The photografted polyaniline layer was further functionalized by reacting the epoxy groups of photografted glycidyl methacrylate copolymer by immersing them in ethylenediamine, hexamethylenediamine, and cystamine for 1 hour at room temperature. Characterization

The surface of the PANI layers was sputtered with a thin layer of gold and the morphology imaged using analytical Ultra-55 scanning electron microscope (Carl Zeiss, Peabody, Mass.). The thickness of the polyaniline layer was estimated from SEM images acquired with membranes broken in liquid nitrogen.

Permeability and selectivity of the membranes, both dry and wetted with water, were determined for the separation of carbon dioxide from its mixture with methane. The measurements were carried out using in-house assembled flow system. The PANI-composite membranes were placed in a permeation cell with an effective permeation area of 2.01 cm². The feed gas consisted of 90% methane and 10% carbon dioxide. Helium was used as a sweep gas and was passed over the permeate side of the membrane. The feed gas flow was controlled by a mass flow controller and the exiting flow was measured with a digital flow meter. After introduction of the feed gas, the system was allowed to reach a steady state. Composition of both permeate and retentate gases was determined using SRI Model 8610C gas chromatograph equipped with a 6-foot CTR column packed column and a thermal conductivity detector. All tests were performed at room temperature.

### Results and Discussion

### Morphology

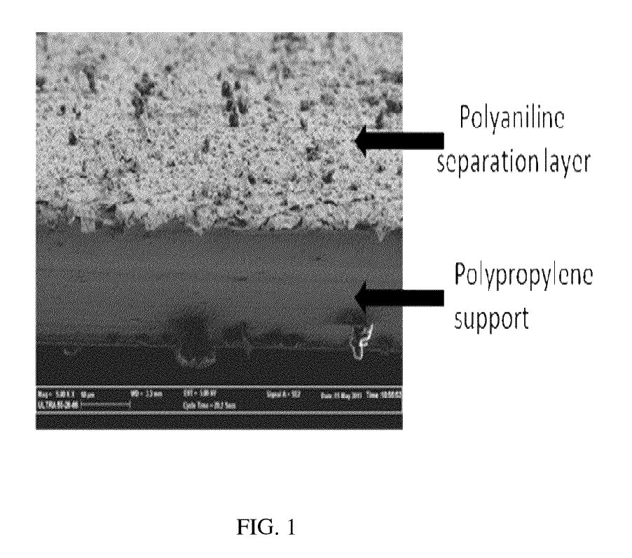

FIG. 1 illustrates a SEM micrograph of a cross section of PANI-polypropylene composite membrane prepared by dispersion polymerization. The morphology of PANI layers on porous polypropylene support affects properties of the composite membrane designed for the gas separation. Therefore, we focused on the preparation of membranes with homogeneous PANI coating with no defects such as cracks and holes. The PANI layer prepared by precipitation polymerization has a granular morphology. Dispersion and emulsion polymerization in presence of poly(N-vinylpyrrolidone) (steric stabilizer) and dodecylbenzenesulfonic acid (surfactant), respectively, affords PANI film with a better quality. The steric stabilizer prevents macroscopic precipitation of PANI and the contamination of films with the precipitate. The surfactant reduces the surface tension at the interface polypropylene support-aqueous polymerization mixture thus decreasing the adhesion of air microbubbles that block access of the polymerization mixture to the surface of the support. The absence of microbubbles largely eliminates the undesired defects such as pinholes.

The PANI layers prepared using dispersion process are thinner compared to those prepared using precipitation polymerization. The layer thickness is also controlled by kinetic parameters such as reaction temperature and concentration of the reagents in the polymerization mixture. For example, both a decrease in reaction temperature and an increase in concentration of the reagents afford thicker layers. Addition of a heteropolyacid-tungstosilicic acid, which decreases the rate of nucleation during induction period and also inhibits polymerization of aniline, helps to increase thickness of the layer. The longer the nucleation period with delayed propagation, the more nuclei formed and adsorbed at the surface of polypropylene support, and the thicker the polyaniline film. Consequently, the surface of the PANI layer is more compact.

### Gas Permeation

Transport properties of the PANI-composite membrane at ambient temperature are shown in Table 1 below. The dry membrane has a poor permeability and no appreciable selectivity for carbon dioxide over methane. In contrast, hydration of the membrane with water significantly increased both of the parameters.

TABLE 1
Properties of PANI-Composite Membranes Prepared
by Precipitation Polymerization at 5° C.

| | Permeability for | Selectivity |
|---|---|---|
| Membrane | CO₂ Barrer | CO₂/CH₄ |
| dry | 155 | 1.1 |
| wet | 3,893 | 15.3 |

While the wetted membrane exhibits reasonable permeability, the selectivity is not sufficient for any real-life applications. In order to further increase the selectivity, we photografted the PANI layer with a mixture of 2-hydroxyethyl methacrylate and glycidyl methacrylate followed by reaction of the epoxy groups with diamines such as ethylenediamine, hexamethylenediamine, and cystamine. This modification affords membranes featuring both hydrophilic and amine functionalities that serve as fixed carriers and enhance selectivity.

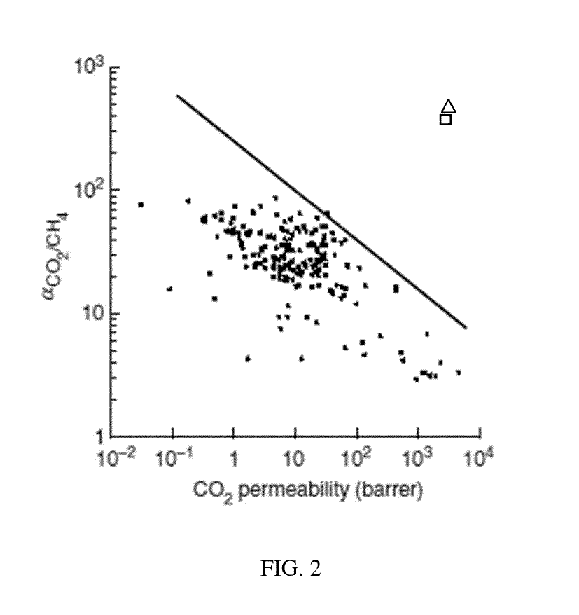

FIG. 2 illustrates a permeability/selectivity trade-off map for CO₂/CH₄ including the polyaniline membrane photografted with glycidyl methacrylate and 2-hydroxyethyl methacrylate and reacted with cystamine (open triangle) and hexamethylenediamine (open square).

FIG. 2 also demonstrates that the functionalized PANI-composite membranes exhibit exceptional performance and significantly exceed values typically shown in common trade-off plots. For example, the photografted membrane modified with cystamine is characterized with a permeability of 3470 barrer and a CO₂/CH₄ selectivity of 388.

In an additional embodiment, we present a reliable alternative method for the preparation of highly selective polymer membranes by replacing water with a less volatile liquid, poly(ethylene glycol) (PEG). PEG can dissolve a substantial amount of CO₂ because of the presence of polar moieties in its main chains and high segmental flexibilities. Moreover PEGs have low vapor pressures, low toxicity and low or moderate cost, therefore much research has been carried out using this polymer. It is difficult to obtain a thin film of PEG alone because its mechanical and thermal strength is weak. Thus, highly stable membranes were obtained by blending PEG with other polymers, where the PEG segment provides high permeability coefficients and high permselectivities, and the other polymers provide robustness to the membranes. The blended membranes containing PEG showed high CO₂ diffusivity coefficients, resulting in high permeability coefficients for CO₂. Kawakami et al. was the first who reported that the permeability and CO₂ permselectivity of cellulose nitrate/PEG blended membranes increase appreciably with increasing PEG fraction. The significant increase in CO₂ permeability was attributed to the increments to both diffusivity and solubility of CO₂. Davis et al. developed a model to describe the transport process for facilitated transport using amine-poly (ethylene glycol) membranes. A particular problem with liquid membranes though is that there is solvent loss by evaporation.

To address this problem, an embodiment describes a method to impregnate a membrane surface with PEG. The effects of the molecular weight of PEG and rotation speed of spin coating on the formation of the uniform layer and permselectivity of the membranes was investigated.

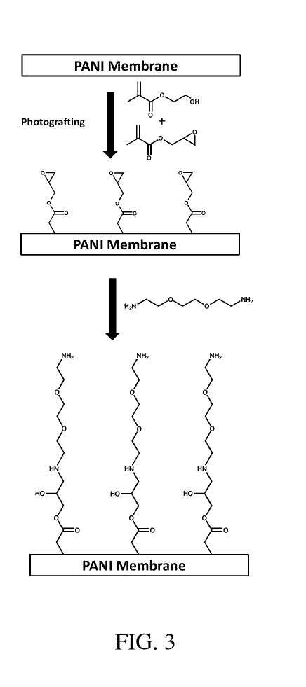

FIG. 3 illustrates a scheme of functionalization of a polyaniline membrane first photografted with glycidyl methacrylate and 2-hydroxyethyl methacrylate and then reacted with 2-2′-(ethylenedioxy)bis(ethylamine). The surface of the composite PANI membranes was functionalized via photografting of a mixture of 2-hydroxyethyl methacrylate and glycidyl methacrylate to afford both hydrophilicity and reactivity followed by post-grafting ring opening reaction with 2-2′-(ethylenedioxy)bis(ethylamine), leading to more basic immobilized functionalities that produces highly permeable membranes that readily adsorb water and significantly facilitate selective transport of CO₂.

Goniometric analysis confirmed the hydrophilic nature of the membrane after this functionalization. The contact angle changed from 65 degrees for a presitine PANI membrane to 28 degrees and demonstrated the desired increase in hydrophilicity of the membrane surface. The functionalization of the surface was also confirmed by X-ray photoelectron spectroscopy (XPS) analysis. Table 2 shows the elemental composition of the surface layer of these membranes.

TABLE 2
Chemical composition of surface of functionalized polyaniline
membranes determined using XPS quantitative analysis

| | Oxygen, | Carbon, | Nitrogen, |
|---|---|---|---|
| Functionality | at. % | at. % | at. % |
| None | 34 | 61.5 | 4.4 |
| (emeraldine | | | |
| base PANI) | | | |
| Photografted | 28.3 | 66.1 | 5.6 |

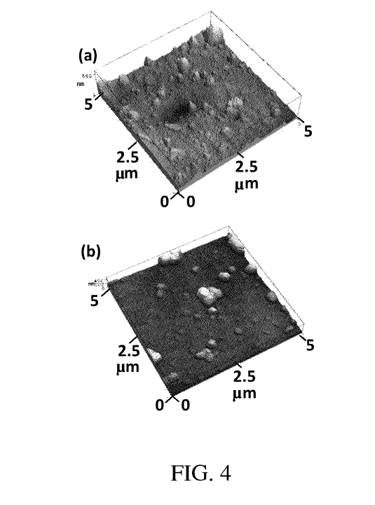

FIG. 4 illustrates topographic AFM images of (a) original polyaniline layer, and (b) after photografting with glycidyl methacrylate and 2-hydroxyethyl methacrylate followed by modification with 2-2′-(ethylenedioxy)bis(ethylamine). The size of scanned window is 5×5 μm). The AFM images show surface morphology of the original polyaniline film prepared by precipitation polymerization at 5° C., and after modification with 2-2′-(ethylenedioxy)bis(ethylamine). The membranes exhibit a globular morphology with some precipitated PANI particles distributed over the entire scanned area. The average size of the globules is 55 nm for parent PANI film and 134 nm for PANI film modified with 2-2′-(ethylenedioxy)bis(ethylamine). A significant distinction in the globules size between parent and functionalized PANI film confirms successful surface modification. Table 3 shows the root-mean square roughness and mean roughness for PANI films before and after modification.

TABLE 3
Mean roughness Rₐ and root-mean square roughness
Rₘₛ determined from AFM images for polyaniline
films before and after modification.

| Functionality | Rₐ, nm | Rₘₛ, nm |
|---|---|---|
| None (emeraldine base PANI) | 20.6 | 26.22 |
| 2-2′-(ethylenedioxy)bis(ethylamine) | 36.3 | 61.3 |

Finally, solutions of PEG with molecular weights varying from 200 to 1000 were deposited by spin coating on top of photografted PANI-composite film. Permeation experiments were performed using CO₂/CH₄ (10/90 by volume) gas mixture at room temperature. After introduction of the feed, the system was allowed to reach a steady state. The composite PANI film functionalized with 2,2′-(ethylenedioxy) bis (ethylaniline) shows selectivity of 4 towards CO₂ and permeability of 6.8 in a dry state. In order to increase the permselectivity, we studied the effect the amount of adsorbed PEG on gas transport and efficiency of the separation.

At first, PEG with molecular weight of 200 and 400 were spin-coated onto the surface of the photografted PANI-composite films. 50% solutions of PEG were spun at 2000 rpm for 180 s to form a uniform layer. The use of PEG increased the CO₂ diffusivity, as well as CO₂ solubility due to the presence of EO units. As can be seen from Table 4, the presence of PEG enhanced both, permeability coefficient and separation factor. PEG 400 had higher selectivity for CO₂ than PEG 200 (193.8 and 19.2 respectively).

TABLE 4
Gas transport properties of composite PANI membranes
functionalized with 2-2′-(ethylenedioxy)bis(ethylamine)
containing 50% PEG 200 and PEG 400.

| | | Permeability | | |
|---|---|---|---|---|
| | | coefficient | Separation | |
| | g PEG/ | for CO₂ | factor | Δp_{CO2} |
| PEG, MW | g polymer | Barrer | α CO₂/CH₄ | kPa [a] |
| 200 | 0.107 | 36.5 | 19.2 | 9.42 |
| 400 | 0.162 | 45.9 | 193.8 | 9.36 |

[a] (Partial pressure difference of carbon dioxide across the membrane)

Then we prepared the coating with different concentrations of PEG 400 spin coated at 2000 rpm for 180 s. Viscosity is another key parameter in the design of membrane system because of the use of liquids. This is related to the concentrations of the reagents in water solutions. An increase of the concentration should involve a better CO₂ removal since the selectivity and permeability are given by the interaction with the solvent. As content of PEG 400 increased, the permeability and selectivity towards CO₂ increased and reached 88 Barrers and separation factor of 442 for 80% PEG 400 (Table 5).

TABLE 5
Gas transport properties of composite PANI membranes
functionalized with 2-2′-(ethylenedioxy)bis(ethylamine)
containing various content of PEG 400.

| | | Permeability | | |
|---|---|---|---|---|
| | | coefficient | Separation | |
| PEG 400, | g PEG/ | for CO₂ | factor | Δp_{CO2} |
| % | g polymer | Barrer | α CO₂/CH₄ | kPa |
| 20 | 0.042 | 14.3 | 107.2 | 9.41 |
| 40 | 0.098 | 31.9 | 146.6 | 9.41 |
| 50 | 0.21 | 45.9 | 193.8 | 9.42 |
| 80 | 0.27 | 88 | 442.2 | 9.36 |

Because of the higher viscosity of PEG 400, the flux of the CO₂ is lower than those obtained from water (Table 6). Increase in viscosity decreases the mobility of CO₂ carrier. However, using water as solvent is very energy-intensive because of the high heat capacity of water. Other limitations of using aqueous amine solutions for industrial CO₂ capture include metal hardware corrosion, amine degradation, and solvent loss.

TABLE 6
Gas transport properties of composite PANI membranes
functionalized with 2-2′-(ethylenedioxy)bis(ethylamine)
containing various content of water.

| Water | Permeability | | |
|---|---|---|---|
| content, | coefficient | Separation | |
| g water/ | for CO₂ | factor | Δp_{CO2} |
| g polymer | Barrer | αCO₂/CH₄ | kPa |
| 0.69 | 939.3 | 24.8 | 24.8 |
| 1.37 | 1727.2 | 407.1 | 407.1 |
| 2.05 | 2550.2 | 790.9 | 790.9 |
| 2.74 | 3381.8 | 606.8 | 606.8 |

The relationship between the PEG content and the permeation rates of the gases CO₂ and CH₄ was investigated. The PEG content was defined as a ration of PEG weight to the total weight of the photografted PANI composite membrane. Our results indicate that the amount of CO₂ separated from the feed directly relates to the PEG content in the membrane, which directly related to the rotation speed of spin coating of PEG in the membrane.

The composite membranes containing 80% PEG 400, PEG 600 and PEG 1000 featured selectivities of 442, 640 and 871 and permeabilities of 88, 131 and 217 barrers, respectively (Table 7) when PEG was spincoated at 2000 rpm for 180 s. That is the highest polymer CO₂/CH₄ selectivity we have achieved so far.

TABLE 7
Gas transport properties of composite PANI membranes functionalized
with 2-2′-(ethylenedioxy)bis(ethylamine) containing 80% of PEG
with various molecular weight spin coated at 2000 rpm for 180 s.

| | | Permeability | | |
|---|---|---|---|---|
| | | coefficient | Separation | |
| | g PEG/ | for CO₂ | factor | Δp_{CO2} |
| PEG MW | g polymer | Barrer | αCO₂/CH₄ | kPa |
| 400 | 0.27 | 88 | 442 | 9.36 |
| 600 | 0.24 | 131 | 639 | 9.05 |
| 1000 | 0.45 | 217 | 871 | 9.09 |

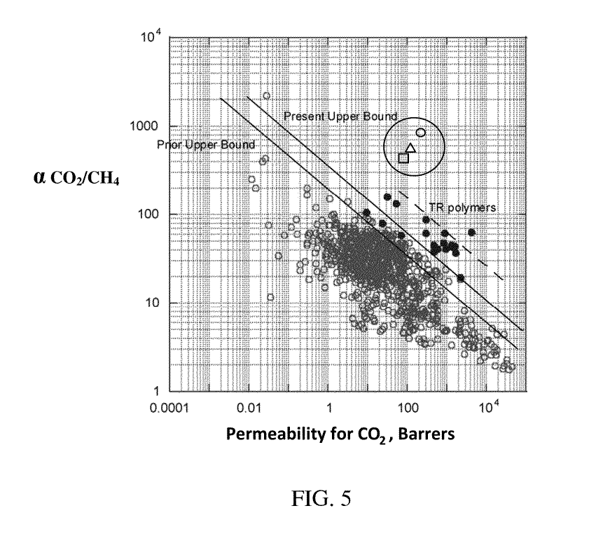

When using different spin coating profiles: a ramp from 0 to 2000 rpm was driven for 2 s, followed by another ramp from 2000 to 4000 for 120 s, the permselectivities towards CO₂ decreases (Table 8) since PEG content in the membrane decreases. Our results significantly exceed all other results included in the updated upper bound (see FIG. 5).

TABLE 8
Gas transport properties of composite PANI membranes
functionalized with 2-2′-(ethylenedioxy)bis(ethylamine)
containing 80% of PEG with various molecular weight spin
coated at 2000 rpm for 2 s, 4000 rpm for 120 s

| | | Permeability | | |
|---|---|---|---|---|
| | | coefficient | Separation | |
| | g PEG/ | for CO₂ | factor | Δp_{CO2} |
| PEG MW | g polymer | Barrer | αCO₂/CH₄ | kPa |
| 400 | 0.13 | 67 | 428 | 9.06 |
| 600 | 0.19 | 101 | 503 | 9.09 |
| 1000 | 0.37 | 179 | 786 | 9.36 |

### Experimental

Deep UV irradiation was carried out with a Hg/Xe 500 W short-arc lamp (UXM-501MA) from Ushio America. Atomic force microscopy images were obtained using SmartSPM instrument (AIST-NT, Inc., Novato, Calif., USA) in semicontact mode. A PHI 5400 ESCA system (PerkinElmer, Waltham, Mass., USA) including an Al anode (primary photon energy of 1486.6 eV) and a X-ray source with a power of 150 W (15 kV at 10 mA) was used for XPS measurements. Membranes were dried prior these measurements at 100° C. for 48 h. Easy Drop Goniometer (Krüss GmbH, Germany) was used to determine the contact angle of a water droplet with a volume of 2 μL placed on the film surface. The spin deposition was done by means of a spincoater P6700 (specialty coating system, Inc. IN, PH, USA).

### Film Fabrication

Composite membranes combining polyaniline as an active layer with polypropylene support (43 nm pores, Celgard Inc., Charlotte, N.C., USA) were prepared using an in situ deposition technique. The protonated polyaniline was converted into an emeraldine base by treatment with an excess of 0.1 mol/L ammonium hydroxide.

### Film Modification

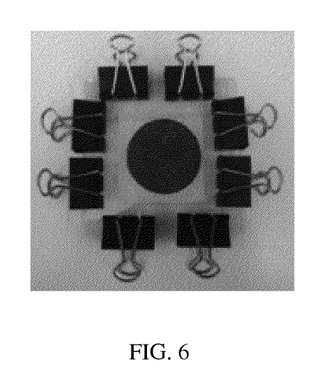

The surface of PANI-composite membrane was modified using a photografting procedure described previously. The PANI-composite membrane was wetted between two fluorinated quartz plates with a photografting mixture containing glycidyl methacrylate (25 wt %), 2-hydroxyethyl methacrylate (25 wt %), and t-butyl alcohol-water mixture (50 wt %) (3:1, v/v) (see FIG. 6). The quartz plates were fixed with multiple clamps and put under a deep UV lamp at 360 nm at a distance of 23 cm for 15 min in a closed system. After completion of the UV exposure, the quartz plates were carefully opened and membrane was immediately immersed in 1,4-dioxane for about 1 h to dissolve all soluble polymers at its surface, then washed with methanol, and dried. The PANI layer, photografted with poly(glycidyl methacrylate-co-2-hydroxyethyl methacrylate), was further modified by immersing at room temperature for 3 h in a 2 mol/L aqueous solution of 2-2′-(ethylenedioxy)bis(ethylamine), then washed with methanol, and dried.

### Activation of Quartz Plates

The quartz plates were washed with water, dried with a stream of nitrogen, and immersed in a 1 M sodium hydroxide solution for 0.5 h. Then the plates were washed again with water and dried, after that they were immersed in a 1 M hydrochloric acid solution for 0.5 h, washed with water, and dried extensively with a stream of nitrogen.

### Fluorination of the Quartz Plates

To create inert, fluorinated glass slides, the activated quartz plates were placed in a desiccator together with an open vial containing several droplets of trichloro(1 H,1 H,2 H,2 H-perfluorooctyl)silane. The desiccator was evacuated and left under vacuum overnight, followed by washing the fluorinated quartz plates with acetone.

Mixed-gas permeability coefficients were measured using a constant-pres sure/variable-volume system equipped with a gas chromatograph. Helium was used as a sweep gas and was passed over the permeate side of the membrane. After introduction of the feed, the system was allowed to reach a steady state. All mixed gas tests were performed at room temperature. The total operating gas pressure was approximately 128 kPa for the feed and less than 100 kPa for the permeate.

The permeability coefficient of individual components in the gas mixture passing through the membrane was obtained by using equation 1:

P_{CO2}=x^{P}_{CO2} S l/x^{P}_{He}A Δp_{CO2} (1)

where P_{CO2} is the permeability of carbon dioxide, x^{P}_{CO2} is the molar fraction of carbon dioxide in the permeate stream, S is the helium sweep gas flow rate (2 cm³/min), l is the thickness of selective layer, x^{P}_{He} is the molar fraction of helium in the permeate stream, A is the area of the membrane (2.01 cm²), and Δp_{CO2} is the partial pressure difference of carbon dioxide across the membrane.

The separation factor α is given by equation 2:

α_{CO2/CH4}=(y_{CO2}/y_{CH4})/(x_{CO2}/x_{CH4}) (2)

where x is the molar fraction of each gas on the feed side and y the molar fraction of each gas on the permeate side determined from gas chromatography measurements. The value in denominator x_{CO2}/x_{CH4}=0.11 remains constant in all experiments.

### Conclusions

Various embodiments demonstrate that the in-situ polymerization enables deposition of homogeneous polyaniline layer with controlled thickness on top of the porous polypropylene support. Photografting and subsequent modification with diamines affords composite membranes featuring both high permeability and selectivity that are well suited for applications such as separation of carbon dioxide from natural gas.

What is claimed is:

1. A composition of matter comprising:
a polyaniline polymer thin film with functional groups grafted thereto.

2. The composition of matter of claim 1, wherein the polyaniline polymer thin film is modified by photografting at least one functional group selected from the group consisting of a glycidyl methacrylate, a 2-hydroxyethyl methacrylate, and a benzophenone.

3. The composition of matter of claim 2, wherein polyaniline polymer thin film is further functionalized by reacting an epoxy group of a photografted glycidyl methacrylate with at least one of a diamine selected from the group consisting of an ethylenediamine, a hexamethylenediamine, a cystamine, and a 2-2′-(ethylenedioxy)bis(ethylamine).

4. The composition of matter of claim 1, wherein the polyaniline polymer thin film further comprises a solvent.

5. The composition of matter of claim 4, wherein the solvent is selected from the group consisting of water and poly(ethylene glycol) (PEG).

6. The composition of matter of claim 1, wherein the polyaniline polymer thin film further comprises a poly(ethylene glycol) (PEG).

7. The composition of matter of claim 6, wherein the poly(ethylene glycol) (PEG) is spin coated onto the polyaniline polymer thin film.

8. The composition of matter of claim 1, wherein the polyaniline polymer thin film is approximately defect free with no holes, pin holes, cracks or voids greater than one nanometer (nm).

9. The composition of matter of claim 1, wherein the polyaniline polymer thin film thickness is approximately in a range from 20 nm to 200 nm.

10. A composite membrane for separation of a gas mixture comprising:
a porous support layer; and
a polyaniline polymer thin film with amine functional groups grafted thereto.

11. The composite membrane of claim 10, wherein the porous support layer comprises a porous polypropylene polymer support layer.

12. The composite membrane of claim 11, wherein the porous polypropylene polymer support layer has a thickness in a range of 1 μm to 50 μtm, and a pore size in a range of 0.010 μm to 0.080 μm.

13. The composite membrane of claim 10, wherein the gas mixture comprises carbon dioxide (CO₂) and methane (CH₄).

14. The composite membrane of claim 10, wherein polyaniline polymer thin film is modified by photografting at least one functional group selected from the group consisting of a glycidyl methacrylate, a 2-hydroxyethyl methacrylate, and a benzophenone.

15. The composite membrane of claim 14, wherein polyaniline polymer thin film is further functionalized by reacting an epoxy group of a photografted glycidyl methacrylate with at least one of a diamine selected from the group consisting of an ethylenediamine, a hexamethylenediamine, a cystamine, and a 2-2′-(ethylenedioxy)bis(ethylamine).

16. The composite membrane of claim 10, wherein the polyaniline polymer thin film further comprises a solvent.

17. The composite membrane of claim 16, wherein the solvent is selected from the group consisting of water and poly(ethylene glycol) (PEG).

18. The composite membrane of claim 10, wherein the polyaniline polymer thin film further comprises a poly(ethylene glycol) (PEG).

19. The composite membrane of claim 18, wherein the poly(ethylene glycol) (PEG) is spin coated onto the polyaniline polymer thin film.

20. The composite membrane of claim 10, wherein the polyaniline polymer thin film is approximately defect free with no holes, pin holes, cracks or voids greater than one nanometer (nm).

21. The composite membrane of claim 10, wherein the polyaniline polymer thin film thickness is approximately in a range from 20 nm to 200 nm.
